(19) United States
(12) Patent Application Publication
(10) Pub. No.: US 2026/0098751 A1
(43) Pub. Date: Apr. 9, 2026

(54) FLOWMETER WET GAS REMEDIATION DEVICE AND METHOD

(71) Applicant: MICRO MOTION, INC., Boulder, CO (US)

(72) Inventors: David Martinez MORETT, Fort Collins, CO (US); Cornel GAZDARU, Fort Collins, CO (US); Joel WEINSTEIN, Boulder, CO (US)

(73) Assignee: MICRO MOTION, INC., Boulder, CO (US)

(21) Appl. No.: 19/112,791

(22) PCT Filed: Sep. 19, 2023
(86) PCT No.: PCT/US2023/033121

§ 371 Date: Mar. 18, 2025

Related U.S. Application Data
(60) Provisional application No. 63/411,884, filed on Sep. 30, 2022.

(51) Int. Cl. G01F 15/02; G01F 1/84

(52) U.S. Cl. CPC G01F 15/024; G01F 1/8436; G01F 1/8468

(57) ABSTRACT

A method for improving flowmeter accuracy is provided. The flowmeter comprises at least one flow tube, at least one pickoff sensor attached to the flow tube, at least one driver attached to the flow tube, and meter electronics in communication with the at least one pickoff sensor and driver. The method comprises the steps of vibrating at least one flow tube in a drive mode vibration with the at least one driver and receiving a sensor signal based on a vibrational response to the drive mode vibration from the at least one pickoff sensor. An unremediated density is derived with the flowmeter. An unremediated mass flow is derived with the flowmeter. An extended drive gain is derived with the flowmeter. At least one flow variable is received. A density ratio is calculated. A plurality of wet gas coefficients is provided. A dry gas mass flow rate is calculated with the density ratio and at least one of the plurality of wet gas coefficients.

### FIELD OF THE INVENTION

The present invention relates to flowmeters, and more particularly, to Coriolis-based measurement methods and related devices that provide greater accuracy of multi-phase fluid flow.

### BACKGROUND

Vibrating conduit sensors, such as Coriolis mass flowmeters and vibrating densitometers, typically operate by detecting motion of a vibrating conduit that contains a flowing material. Properties associated with the material in the conduit, such as mass flow, density and the like, can be determined by processing measurement signals received from motion transducers associated with the conduit. The vibration modes of the vibrating material-filled system generally are affected by the combined mass, stiffness, and damping characteristics of the containing conduit and the material contained therein.

A typical Coriolis mass flowmeter includes one or more conduits (also called flow tubes) that are connected inline in a pipeline or other transport system and convey material, e.g., fluids, slurries, emulsions, and the like, in the system. Each conduit may be viewed as having a set of natural vibration modes, including for example, simple bending, torsional, radial, and coupled modes. In a typical Coriolis mass flow measurement application, a conduit is excited in one or more vibration modes as a material flows through the conduit, and motion of the conduit is measured at points spaced along the conduit. Excitation is typically provided by a driver, e.g., an electromechanical device, such as a voice coil-type actuator, that perturbs the conduit in a periodic fashion. Mass flow rate may be determined by measuring time delay or phase differences between motions at the transducer locations. Two or more such transducers (or pickoff sensors) are typically employed in order to measure a vibrational response of the flow tube or conduits and are typically located at positions upstream and downstream of the driver. Instrumentation receives signals from the pickoff sensors and processes the signals in order to derive a mass flow rate measurement.

Flowmeters are used to perform mass flow rate measurements for a wide variety of fluid flows. One area, for example, in which Coriolis flowmeters can potentially be used is in the metering of oil and gas wells. The product of such wells can comprise a multiphase flow, including the oil or gas, but also including other components, such as water and/or solids, for example. It is, of course, highly desirable that the resulting metering be as accurate as possible, even for such multiphase flows.

Coriolis meters offer high accuracy for single phase flows. However, when a Coriolis flowmeter is used to measure aerated fluids, fluids including entrained gas, or gas flows having a liquid component (i.e. “wet gas”), the accuracy of the meter can be degraded. This is similarly true for flows having entrained solids and for mixed-phase fluid flows, such as when hydrocarbon fluids contain water.

Coriolis meters were historically designed to measure single-phase processes. Coriolis technology is unique in that it measures both the mass flow and density of the process fluid simultaneously and independently. If there are only two phases that need to be independently measured in a process (i.e. liquid and gas) and the densities at process conditions of the two phases are known, this would be enough information to provide an overall mass flow rate along with phase fraction. When multiple phases are present, some of the basic assumptions made in Coriolis measurement break down. In particular, the fluid no longer vibrates in sync with the flow tubes, resulting in measurement errors.

Overall, when a Coriolis meter experiences the onset of multi-phase flow, the sensor tube vibration is damped, resulting in the diminishment of flow tube vibratory amplitude. Typically, meter electronics compensate for this diminished amplitude by increasing the drive energy, or drive gain, in order to restore the amplitude. There is, however, a ceiling, as the maximum drive energy is limited for safety and other reasons. Therefore, as multi-phase flow becomes more pronounced, the relative measurable drive amplitude diminishes, which can no longer be augmented, as the driver is already performing at 100% drive gain. At this point, the meter electronics will continue to drive the tube vibration with diminished amplitude. In cases where multi-phase flow is even more severe, the amplitude of vibration becomes up to, and even greater than, an order of magnitude less than for single-phase flow. In addition to these challenges, the presence of bubbles or droplets of differing density to the main carrying phase causes decoupling of the droplets from the surrounding fluid. The magnitude of the decoupling depends on many flowmeter and process fluid conditions, such as viscosity, droplet or bubble size, and flowmeter vibratory frequency. This decoupling phenomenon results in measurements that are less than the actual values, for both density and mass flow rate. Decreases in tube amplitude also affect the mass measurement of the Coriolis meter. Similar effects on accuracy occur for wet gas. Conventional guidelines and best practices generally suggest Coriolis meters are not optimized for two phase performance where small amounts of liquid are entrained in gas, and generally conclude that Coriolis meters can have an unpredictable behavior in wet gas conditions.

For the measurement of well performance in oil & gas well testing, for example, a separator is usually used to separate liquid from gas or separate oil from water and gas. In either case, the individual phases are measured separately with individual flowmeters. These separators are typically large, heavy pressure vessels having numerous level controls, safety valves, level sensors, control valves, piping, flowmeters, and interior devices to promote efficient separation. Such separators are usually prohibitively expensive, such that one separator must be shared by multiple wells for well testing. A manifold is usually provided that allows the wells to be tested one at a time, typically for a 24-hour test.

What is needed is a flowmeter that accurately functions without compositional fluid analysis or other inputs beyond readily available process measurements. The present embodiments provide apparatuses and methods for wet gas applications that improve measurement accuracy. The embodiments may directly make wellhead measurements, but also may be employed in any flowmeter application. Advancements in the art are thus achieved.

### SUMMARY OF THE INVENTION

According to an aspect, a method for improving flowmeter accuracy comprises a flowmeter that further comprises at least one flow tube, at least one pickoff sensor attached to the flow tube, at least one driver attached to the flow tube, and meter electronics in communication with the at least one pickoff sensor and driver. The method comprises the steps of vibrating at least one flow tube in a drive mode vibration with the at least one driver and receiving a sensor signal based on a vibrational response to the drive mode vibration from the at least one pickoff sensor. An unremediated density is derived with the flowmeter. An unremediated mass flow is derived with the flowmeter. An extended drive gain is derived with the flowmeter. At least one flow variable is received. A density ratio is calculated. A plurality of wet gas coefficients is provided. A dry gas mass flow rate is calculated with the density ratio and at least one of the plurality of wet gas coefficients.

According to an aspect, a meter electronics for a flowmeter configured to improve measurement accuracy is provided. The flowmeter comprises at least one flow tube, at least one pickoff sensor attached to the at least one flow tube, and at least one driver attached to the flow tube. The meter electronics are in communication with the at least one pickoff sensor and the at least one driver and configured to vibrate at least one flow tube in a drive mode vibration with the at least one driver and receive a sensor signal based on a vibrational response to the drive mode vibration from the at least one pickoff sensor. The meter electronics is further configured to derive an unremediated density with the flowmeter, derive an unremediated mass flow with the flowmeter, and derive an extended drive gain with the flowmeter. At least one flow variable is received. A density ratio is calculated. A plurality of wet gas coefficients is provided; and a dry gas mass flow rate is calculated with the density ratio and at least one of the plurality of wet gas coefficients.

### Aspects

According to an embodiment, a method for improving flowmeter accuracy is provided. The flowmeter comprises at least one flow tube, at least one pickoff sensor attached to the flow tube, at least one driver attached to the flow tube, and meter electronics in communication with the at least one pickoff sensor and driver. The method comprises the steps of vibrating at least one flow tube in a drive mode vibration with the at least one driver and receiving a sensor signal based on a vibrational response to the drive mode vibration from the at least one pickoff sensor. An unremediated density is derived with the flowmeter. An unremediated mass flow is derived with the flowmeter. An extended drive gain is derived with the flowmeter. At least one flow variable is received. A density ratio is calculated. A plurality of wet gas coefficients is provided. A dry gas mass flow rate is calculated with the density ratio and at least one of the plurality of wet gas coefficients.

Preferably, the flow variable comprises pressure, and wherein the pressure is one of a measured input and a user input.

Preferably, the flow variable comprises water cut.

Preferably, the water cut is measured with a water cut analyzer in communication with the meter electronics.

Preferably, the flow variable comprises temperature.

Preferably, the method comprises the step of deriving an extended drive gain with the flowmeter.

Preferably, calculating a density ratio comprises dividing the unremediated density by a dry reference density.

Preferably, the method comprises retrieving the dry reference density from meter electronics.

Preferably, the dry reference density retrieved from meter electronics is determined by at least one of temperature, pressure, and gas composition.

Preferably, the method comprises the step of deriving a liquid mass flow rate by subtracting the dry gas mass flow rate from a remediated mass flow rate.

Preferably, the remediated mass flow rate is derived from the unremediated mass flow rate and a meter factor.

Preferably, the meter factor is derived from an extended drive gain and the plurality of wet gas coefficients.

Preferably, the wet gas coefficients are a function of a plurality of the flow variables.

Preferably, the wet gas coefficients are a function of pressure, gas velocity, drive gain, and water cut.

Preferably, the step of calculating a dry gas mass flow rate with the density ratio and at least one of the plurality of wet gas coefficients comprises using a gas mass ratio derived from the density ratio and the plurality of wet gas coefficients.

Preferably, the gas mass ratio is obtained using density ratio calibration and wet gas coefficients using a quadratic fit.

Preferably, the meter factor is obtained from via an extended drive gain and the plurality of wet gas coefficients using a quadratic fit.

A meter electronics for a flowmeter configured to improve measurement accuracy is provided according to an embodiment. The flowmeter comprises at least one flow tube, at least one pickoff sensor attached to the at least one flow tube, and at least one driver attached to the flow tube. The meter electronics are in communication with the at least one pickoff sensor and the at least one driver and configured to vibrate at least one flow tube in a drive mode vibration with the at least one driver and receive a sensor signal based on a vibrational response to the drive mode vibration from the at least one pickoff sensor. The meter electronics is further configured to derive an unremediated density with the flowmeter, derive an unremediated mass flow with the flowmeter, and derive an extended drive gain with the flowmeter. At least one flow variable is received. A density ratio is calculated. A plurality of wet gas coefficients is provided; and a dry gas mass flow rate is calculated with the density ratio and at least one of the plurality of wet gas coefficients.

Preferably, the flow variable comprises pressure, and wherein the pressure is one of a measured input and a user input.

Preferably, the flow variable comprises water cut.

Preferably, the water cut is measured with a water cut analyzer in communication with the meter electronics.

Preferably, the flow variable comprises temperature.

Preferably, the meter electronics is further configured to derive an extended drive gain.

Preferably, calculating a density ratio comprises dividing the unremediated density by a dry reference density.

Preferably, the meter electronics comprises retrieving the dry reference density from meter electronics.

Preferably, the dry reference density retrieved from meter electronics is determined by at least one of temperature, pressure, and gas composition.

Preferably, the meter electronics is further configured to derive a liquid mass flow rate by subtracting the dry gas mass flow rate from a remediated mass flow rate.

Preferably, the remediated mass flow rate is derived from the unremediated mass flow rate and a meter factor.

Preferably, the meter factor is derived from an extended drive gain and the plurality of wet gas coefficients.

Preferably, the wet gas coefficients are a function of a plurality of the flow variables.

Preferably, the wet gas coefficients are a function of pressure, gas velocity, and water cut.

Preferably, calculating a dry gas mass flow rate with the density ratio and at least one of the plurality of wet gas coefficients comprises using a gas mass ratio derived from the density ratio and the plurality of wet gas coefficients.

Preferably, the gas mass ratio is obtained using density ratio calibration and wet gas coefficients using a quadratic fit.

Preferably, the meter factor is obtained from via an extended drive gain and the plurality of wet gas coefficients using a quadratic fit.

### BRIEF DESCRIPTION OF THE DRAWINGS

FIG. 1 illustrates a flowmeter comprising a meter assembly and meter electronics;

FIG. 2 shows a block diagram of the meter electronics according to an embodiment;

FIG. 3 is a graph illustrating a gas mass ratio as a function of density ratio (apparent/dry gas) for oil (water curves not shown);

FIG. 4 is a graph illustrating a meter factor curve as a function of extended drive gain for oil;

FIG. 5 illustrates an embodiment of the process for determining both gas and liquid mass flow rates for a wet gas flow;

FIG. 6 illustrates the concept of extended drive gain;

FIG. 7 illustrates flowmeter accuracy improvement as a result of implementing a present embodiment.

### DETAILED DESCRIPTION OF THE INVENTION

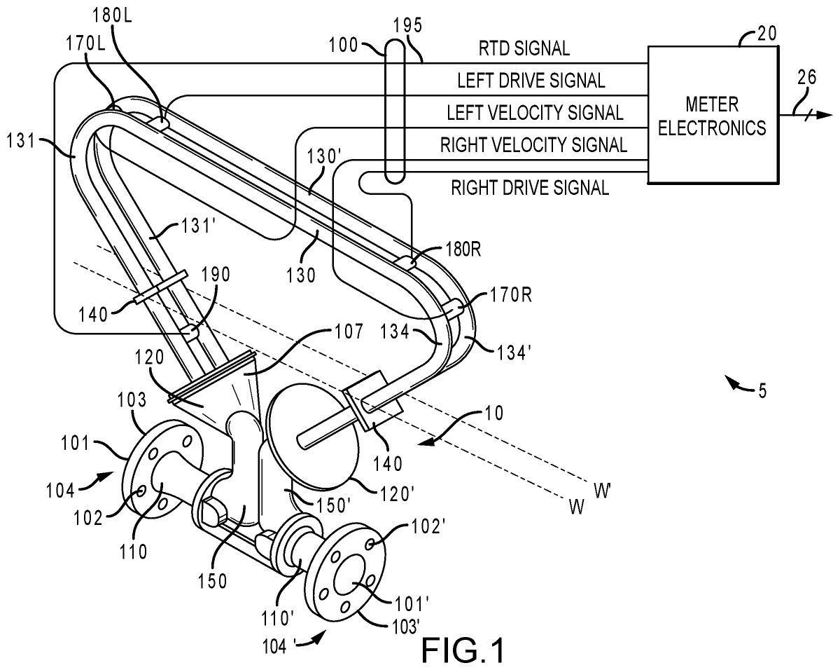

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a vibratory flowmeter 5 according to an embodiment. The flowmeter 5 comprises a sensor assembly 10 and meter electronics 20 coupled to the sensor assembly 10. The sensor assembly 10 responds to at least mass flow rate and density of a process material. The meter electronics 20 is connected to the sensor assembly 10 via leads 100 to provide density, mass flow rate, and temperature information over a communication link 26, as well as other information. A Coriolis flowmeter structure is described although it is apparent to those skilled in the art that the present invention could also be operated as a vibrating tube densitometer.

The sensor assembly 10 includes manifolds 150 and 150′, flanges 103 and 103′ having flange necks 110 and 110′, parallel flow tubes 130 and 130′, first and second drivers 180L and 180R, and first and second pickoff sensors 170L and 170R (for brevity, the drivers and pickoff sensors may herein be collectively referred to as “transducers”). The first and second drivers 180L and 180R are spaced apart on the one or more flow tubes 130 and 130′. In some embodiments, there is only a single driver. In addition, in some embodiments, the sensor assembly 10 may include a temperature sensor 190. The flow tubes 130 and 130′ have two essentially straight inlet legs 131 and 131′ and outlet legs 134 and 134′ which converge towards each other at the flow tube mounting blocks 120 and 120′. The flow tubes 130 and 130′ bend at two symmetrical locations along their length and are essentially parallel throughout their length. The brace bars 140 and 140′ serve to define the axis W and the substantially parallel axis W′ about which each flow tube oscillates. It should be noted that in an embodiment, the first driver 180L may be collocated with the first pickoff sensor 170L, the second driver 180R may be collocated with the second pickoff sensor 170R.

The side legs 131, 131′, 134, 134′ of the flow tubes 130 and 130′ are fixedly attached to flow tube mounting blocks 120 and 120′ and these blocks, in turn, are fixedly attached to the manifolds 150 and 150′. This provides a continuous closed material path through the sensor assembly 10.

When the flanges 103 and 103′, having holes 102 and 102′ are connected, via the inlet end 104 and the outlet end 104′ into a process line (not shown) which carries the process material that is being measured, material enters an inlet end 104 of the flowmeter 5 through an orifice 101 in the flange 103 and is conducted through the manifold 150 to the flow tube mounting block 120. Within the manifold 150, the material is divided and routed through the flow tubes 130 and 130′. Upon exiting the flow tubes 130 and 130′, the process material is recombined in a single stream within the manifold 150′ and is thereafter routed to the outlet end 104′ connected by the flange 103′ having bolt holes 102′ to the process line (not shown) via orifice 101′. The flow fluid can comprise a liquid. The flow fluid can comprise a gas. The flow fluid can comprise a multi-phase fluid, such as a liquid including entrained gases and/or entrained solids; or a gas including entrained liquids.

The flow tubes 130 and 130′ are selected and appropriately mounted to the flow tube mounting blocks 120 and 120′ so as to have substantially the same mass distribution, moments of inertia, and Young's modulus about the bending axes W-W and W′-W′, respectively. These bending axes go through the brace bars 140 and 140′. Inasmuch as the Young's modulus of the flow tubes change with temperature, and this change affects the calculation of flow and density, the temperature sensor 190, which may be a resistive temperature detector (RTD), is mounted to a flow tube 130, 130′ to continuously measure the temperature of the flow tube 130, 130′. The temperature-dependent voltage appearing across the temperature sensor 190 may be used by the meter electronics 20 to compensate for the change in the elastic modulus of the flow tubes 130 and 130′ due to any changes in flow tube temperature. The temperature sensor 190 is connected to the meter electronics 20 by lead 195.

The flow tubes 130, 130′ are typically driven by the driver 180L, 180R in opposite directions about the respective bending axes W and W′ and at what is termed the first out of phase bending mode of the vibratory flowmeter 5. The driver 180L, 180R may comprise one of many well-known arrangements, such as a magnet mounted to the flow tube 130 and an opposing coil mounted to a proximate flow tube 130′. An alternating current is passed through the opposing coil to cause both flow tubes 130, 130′ to oscillate. A suitable drive signal is applied by the meter electronics 20 to the driver 180L, 180R. Other driver devices are contemplated and are within the scope of the description and claims.

The meter electronics 20 receives sensor signals from the sensor assembly 10, and also produces a drive signal which causes a driver 180L, 180R to oscillate the flow tubes 130, 130′. Other sensor devices are contemplated and are within the scope of the description and claims.

The meter electronics 20 processes the left and right velocity signals from the pick-off sensors 170L, 170R in order to compute a flow rate, among other things. The communication link 26 provides an input and an output means that allows the meter electronics 20 to interface with an operator or with other electronic systems.

In one embodiment, the flow tubes 130, 130′ comprise substantially U-shaped flow tubes, as shown. Alternatively, in other embodiments, the flowmeter 5 can comprise substantially straight flow tubes 130, 130′. Additional flowmeter shapes and/or configurations can be used and are within the scope of the description and claims.

The description of FIG. 1 is provided merely as an example of the operation of a flow metering device and is not intended to limit the teaching of the present invention.

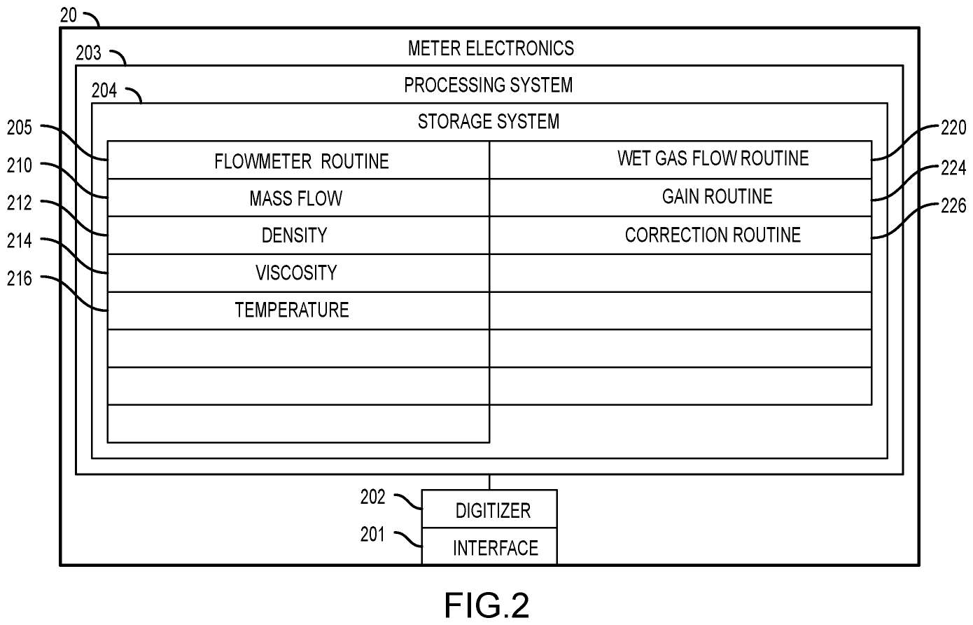

FIG. 2 illustrates meter electronics 20 of the flowmeter 5 according to an embodiment of the invention. The meter electronics 20 can include an interface 201 and a processing system 203. The meter electronics 20 receives transducer signals from the sensor assembly 10, such as pickoff sensor 170L, 170R signals, for example without limitation. The meter electronics 20 processes sensor signals in order to obtain flow characteristics of the flow material flowing through the sensor assembly 10. For example, the meter electronics 20 can determine one or more of a phase difference, a frequency, a time difference (Δt), a density, a mass flow rate, a strain, and a volume flow rate from the sensor signals. In addition, other flow characteristics may be determined in some embodiments.

The interface 201 receives the sensor signals from the transducers via the leads 100 illustrated in FIG. 1. The interface 201 can perform any necessary or desired signal conditioning, such as any manner of formatting, amplification, buffering, etc. Alternatively, some or all of the signal conditioning can be performed in the processing system 203.

In addition, the interface 201 can enable communications between the meter electronics 20 and external devices, such as through the communication link 26, for example. The interface 201 can be capable of any manner of electronic, optical, or wireless communication.

The interface 201 in one embodiment includes a digitizer 202, wherein the sensor signal comprises an analog sensor signal. The digitizer 202 samples and digitizes the analog sensor signal and produces a digital sensor signal. The interface/digitizer 201/202 can also perform any needed decimation, wherein the digital sensor signal is decimated in order to reduce the amount of signal processing needed and to reduce the processing time.

The processing system 203 conducts operations of the meter electronics 20 and processes flow measurements from the sensor assembly 10. The processing system 203 executes one or more processing routines and thereby processes the flow measurements in order to produce one or more flow characteristics.

The processing system 203 can comprise a general-purpose computer, a microprocessing system, a logic circuit, or some other general purpose or customized processing device. The processing system 203 can be distributed among multiple processing devices. The processing system 203 can include any manner of integral or independent electronic storage medium, such as the storage system 204.

The processing system 203 is configured to retrieve and execute stored routines in order to operate the flowmeter 5. The storage system 204 can store routines including a general flowmeter routine 205, a wet gas flow routine 220, a gain routine 224, and correction routine 226. The processing system 203 can determine at least a magnitude, phase difference, time difference, and a frequency of transducer signals. Other measurement/processing routines are contemplated and are within the scope of the description and claims. The storage system 204 can store measurements, received values, working values, and other information. In some embodiments, the storage system may store any one or more of a mass flow (\dot{m}) 210, a density (φ 212, a viscosity (μ) 214, a temperature (T) 216, other values known in the art, and products thereof, for example without limitation. The flowmeter routine 205 can produce and store fluid and flow measurements. These values can comprise substantially instantaneous measurement values or can comprise totaled or accumulated values and may also comprise databases and lookup tables. For example, the flowmeter routine 205 can generate mass flow measurements and store such measurements in the storage system 204. The flowmeter routine 205 can generate density measurements and store them in the storage system 204. Other measurements are contemplated to be similarly generated and stored in the storage system, as will be appreciated by one skilled in the art. The mass flow 210 and density 212 values are determined from the transducer response, as previously discussed and as known in the art. The mass flow 210 can comprise a substantially instantaneous mass flow rate value, can comprise a mass flow rate sample, can comprise an averaged mass flow rate over a time interval, or can comprise an accumulated mass flow rate over a time interval. The time interval may be chosen to correspond to a block of time during which certain fluid conditions are detected, for example, a liquid-only fluid state, or alternatively a fluid state including liquids and entrained gas. In addition, other mass flow quantifications are contemplated and are within the scope of the description and claims.

In an embodiment, flow is sensed by directly measuring the relative motion of the outlet 134, 134′ (or inlet 131, 131′) side of a flowtube 130, 130′ with respect to the inlet 131, 131′ (or outlet 134, 134′) side of the same flowtube 130, 130′. During fluid flow, signal outputs typically have an amplitude and phase that is a function of flow rate. In related embodiments, combined signals from one or more transducers on the inlet side of a meter and the combined signals from one or more transducers on the outlet side of the meter are input into the meter electronics. A phase measurement may be derived from the inlet and outlet signals.

In an embodiment, flow tube 130, 130′ amplitude can be measured by the sensor assembly 10 via the pickoff sensor 170L most proximate the flowmeter 5 inlet. As this pickoff sensor's signal falls below a certain threshold, the uncertainty of the mass flow rate and the uncertainty of the mixture density is generally too great to be considered a reliable measurement. The threshold for which a signal is considered unreliable may be different for mass rate measurements and density measurements, for example. As a multiphase flow is produced through a Coriolis sensor, such as from an oil and gas well, there are often periods of non-measurable flow and periods of measurable, homogenous, flow. The measurable periods are typically characterized by low gas void fraction (GVF) flow in predominantly liquid flow and a low Lockhart-Martinelli (LM) parameter in wet gas flow. The LM is a dimensionless number used in two-phase flow calculations, and expresses the liquid fraction of a flowing fluid. See Proposed Correlation of Data for Isothermal Two Phase Flow, Two Component Flow in Pipes Lockhart, R. W., Martinelli, R. C.; Chem. Eng. Prog., Vol. 45. 1949, pp. 39-48, which is incorporated by reference herein. During these periods of relatively homogenous flow, the mass flow and density error may be low enough to be acceptable for generating reliable measurements. Embodiments provided herein improve upon prior art methods for wet gas flow measurements.

For some of the embodiments provided herein, notably for the wet gas flow routine 220, further described henceforth, flow through the flowmeter will be assumed to comprise three primary portions. First, is the gas core flow. Second, is the liquid film flow that comprises liquid attached to the flow tube walls. Third, is the liquid mist flow, which comprises liquid droplets entrained in the gas core. As an example, for oilfield applications, the entrained liquid in natural gas may be mostly water, mostly condensate (or crude oil), or a mixture of both.

The gas mass ratio is defined as the gas mass flow divided by the total mass flowrate, as shown in Equation (1):

$$x = \frac{{\dot{m}}_{G}}{{\dot{m}}_{G} + {\dot{m}}_{L}} \qquad ( 1 )$$

$$where :$$

$${\dot{m}}_{G} = gass mass flow$$

$${\dot{m}}_{L} = liquid mass flow$$

It is assumed that the flow regime of interest will in most cases be an annular-mist. In this case, the Liquid Entrainment factor, E, is defined as the mass rate of entrained liquid mist (in gas core) relative to the total liquid mass rate, as shown in Equation (2):

$$E = \frac{{\dot{m}}_{L M}}{{\dot{m}}_{L F} + {\dot{m}}_{L M}} = \frac{{\dot{m}}_{L M}}{{\dot{m}}_{L}} \qquad ( 2 )$$

$$where :$$

$${\dot{m}}_{L M} = mass flow rate of the liquid entrapped in the gas core flow \\ \\ ( liquid mist )$$

$${\dot{m}}_{L F} = mass flow rate of the liquid film attached to the tube wall \\ \\ ( liquid film )$$

The slip factor, S, is the ratio of gas superficial velocity, U_{SG}, to the liquid film superficial velocity, U_{SL}, and may be described by Equation (3):

$$S = \frac{{U}_{SG}}{{U}_{SL}} \qquad ( 3 )$$

For most cases, S>1 which means that for the longitudinal flow, the liquid mist entrapped in the gas stream travels at approximately the same velocity as the gas core flow, but the liquid film attached to tube wall travels at a different (lower) velocity than the gas core. This method assumes the multi-phase flow as a steady flow and the calibration considers the slip factor implicitly.

For purposes of flowmeter 5 operation, it will be assumed that the resonant frequency response depends on the gas core and liquid film only, and that the liquid mist contributes to the damping coefficients only. This method suggests that the resonant frequency is independent of damping, though damping would broaden the frequency response around the resonance.

Furthermore, it should be clear that the frequency response would be dependent on the flow rates, as some liquid in the form of droplets would be extracted off the wall liquid film and entrapped in the core gas flow. For purposes of flowmeter 5 operation, calculations may be made in some embodiments that are independent of flow rates.

The natural vibration frequency of the flow tubes 130, 130′ is determined by their stiffness and mass. Since the volume of fluid in the flow tubes 130, 130′ is constant, a change in the density of the fluid causes a change in the mass within the flow tubes 130, 130′. When the mass inside the flow tubes 130, 130′ changes, the natural frequency of the tubes also changes, and this change is detected by the pickoff sensors 170L, 170R. The natural frequency is directly related to the density of the fluid inside the tubes. In embodiments, temperature is measured to compensate for the slight change in the tube stiffness (Young's modulus) with temperature, as will be understood to those skilled in the art.

In embodiments, a density ratio is defined as the measured density over the dry gas density, as exemplified by Equation (4):

$$\frac{{ρ}_{a}}{{ρ}_{G}} = \frac{{ρ}_{Measured}}{{ρ}_{Dry Gas}} \qquad ( 4 )$$

$$where :$$

$${ρ}_{a} = apparent ( unremediated ) density as measured by the Coriolis meter$$

$${ρ}_{g} = gas density at line conditions ( dry reference )$$

With the above relations, if the liquid and gas density at flow conditions are known, and the measured density is known, the gas mass ratio (aka. “gas quality”) can be expressed as a function of liquid entrainment. In an embodiment, lookup tables may be used to obtain liquid and gas density at line conditions. It should be noted that in this embodiment, the E factor is not being calculated, but rather is used as a theoretical framework to establish the use of density ratio so as to obtain the gas mass ratio.

Based on a theoretical decoupling model, it is expected that the measured apparent density, given a constant mass ratio, will vary with the gas velocity. For example, for very high velocity (assume a theoretical value, for example, E˜0.9), most liquid is mist entrained in the gas core, and thus measured density would be very close to the dry gas density (expected density ratio from 1.002 to 1.025). As the gas velocity decreases (for example medium gas velocity, E˜0.5), the density ratio would increase from 1.01 to 1.3 (depending on pressure and gas mass ratio). For low gas velocity (assume, for example, E˜0.1) little liquid mist would be entrained, and the expected density ratio would increase from 1.3 to 1.6 or more. It will be clear that measured density has a strong dependency on the gas mass ratio.

In an embodiment, remediated gas mass flow is obtained from the total remediated mass flow and the gas mass ratio. It is a function of pressure, gas superficial velocity, and water cut.

The density ratio,

$$\frac{{ρ}_{a}}{{ρ}_{G}} ,$$

is expressed as the Coriolis meter density measurement (without corrections) divided by the dry gas density at line conditions as expressed in Equation 4. A table of reference dry gas densities at various temperatures and pressures is retrievable from meter electronics 20. The table reference values may be based upon measured or user inputs. The inputs may comprise one or more of temperature, pressure, and gas composition.

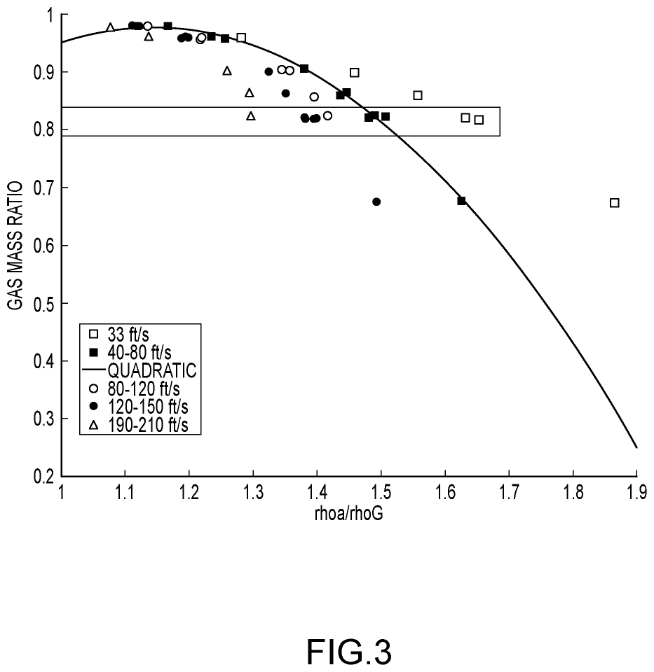

In an embodiment, the density ratio is used to correlate the gas mass ratio. In particular, data are split or filtered by pressure range, gas superficial velocity, and/or water cut. As the data is filtered by these characteristic flow parameters, quadratic equations with lower residual errors are obtained. The gas mass ratio (at a specific pressure, velocity, and water cut) is then obtained from the density ratio calibration using a quadratic fit, as illustrated in FIG. 3, and described by Equation (5):

$$G M {R}_{P , Vel , W C} = {A ( \frac{{ρ}_{a}}{{ρ}_{G}} )}^{2} + B ( \frac{{ρ}_{a}}{{ρ}_{G}} ) + C \qquad ( 5 )$$

$$where :$$

$${GMR}_{P , Vel , WC} = gas mass ratio at a specific pressure , velocity , and water \\ \\ cut ; and$$

$$A , B , C = wet gas coefficients stored in lookup table in meter electronics \\ \\ based upon pressure , velocity , and water cut .$$

Looking more closely at FIG. 3, which is an example of the gas mass ratio as a function of density ratio for oil (water not shown). Note that this is an example, and the actual curve and resultant curve fit/equation will differ based on the particular flow meter and process conditions. With the gas mass ratio known and controlled at lab conditions, one can express E (not shown). Since E depends on the flow velocity, it's expected that the measured apparent density, given a constant quality, will vary with the gas velocity. At a very high velocity, most liquid is mist entrained in the gas core and the measured density is closer to the gas density value. Looking at the points within the rectangle (around 0.8 gas mass ratio), it will be observed that the lowest gas velocity (at ˜33 ft/s) has the highest density ratio, and as velocity increases at a constant gas mass ratio, it is clear that the gas ratio is inversely proportional to the gas velocity.

The meter factor is used to compensate for the decoupling error on the total mass flow rate and is obtained from the extended drive gain, but with discretized calibration curves as a function of pressure, velocity, and water cut. Extended drive gain is drive gain if it were allowed to go above 100%. This is represented by Equation (6):

$${MF}_{P , Vel , WC} = F * ExtD {G}^{2} + G * ExtDG + H \qquad ( 6 )$$

$$where :$$

$${MF}_{P , Vel , W C} = meter factor at a specific pressure , velocity , and water cut ;$$

$$ExtDG = extended drive gain ; and$$

$$F , G , H = wet gas coefficients stored in lookup table in meter electronics \\ \\ based upon pressure , velocity , and water cut .$$

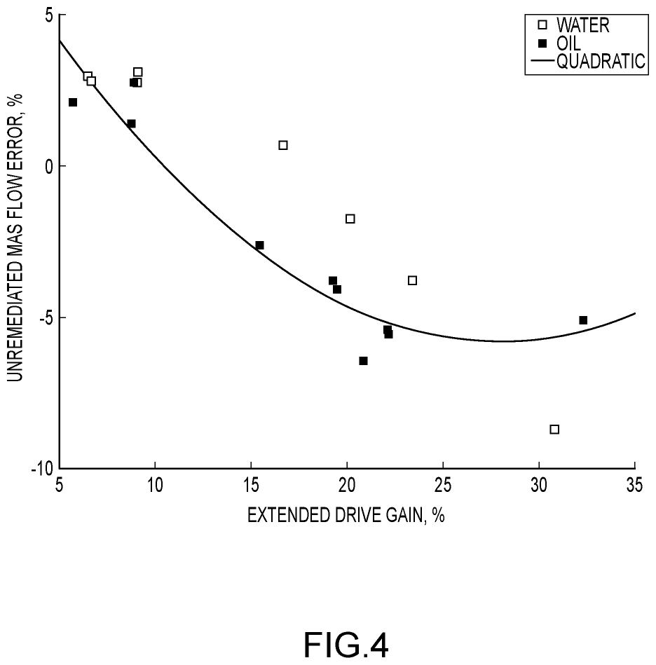

FIG. 4 illustrates an example of a calibration curve used to obtain the meter factor to compensate for the decoupling error on the total mass flow measurement. Note that this is an example, and the actual curve and resultant curve fit/equation will differ based on the particular flow meter and process conditions. The effect of water cut is shown with the oil curve being lower than the water curve. The drive gain is related to flow tube damping and provides an estimate for meter factor correction. The liquid entrainment is a function of pressure, gas velocity, and water cut (in part related to liquid surface tension). For the same drive gain, higher decoupling is expected from oil because water is a polar molecule, whereas oil is not, and water's polarity gives it a high surface tension thus making water droplets harder to detach from the liquid film attached to flow tube walls.

The meter factor from Equation (6) is applied to the unremediated mass flow:

$${RemFlow}_{P , Vel , WC} = \frac{Unremediated mass flow}{1 + {MF}_{P , Vel , WC}} \qquad ( 7 )$$

$$where :$$

$${RemFlow}_{P , Vel , W C} = remediated mass flow rate at a specific pressure , velocity , and water cut .$$

With the remediated total mass flow and the indication of liquid content, gas mass ratio, the dry gas flow rate is calculated:

$${GasFlow}_{P , Vel , WC} = {( RemFlow * GMR )}_{P , Vel , WC} \qquad ( 8 )$$

$$where :$$

$${GαsFlow}_{P , Vel , WC} = dry gas mass flow rate at a specific pressure , velocity , and water cut .$$

The liquid flow rate is simply calculated by subtracting the remediated gas mass flow from the total remediated mass flow:

$${LiqFlow}_{P , Vel , WC} = {RemFlow}_{P , Vel , WC} - {GasFlow}_{P , Vel , WC} \qquad ( 9 )$$

$$where :$$

$${LiqFlow}_{P , Vel , W C} = liquid mass flow rate at a specific pressure , velocity , and water cut .$$

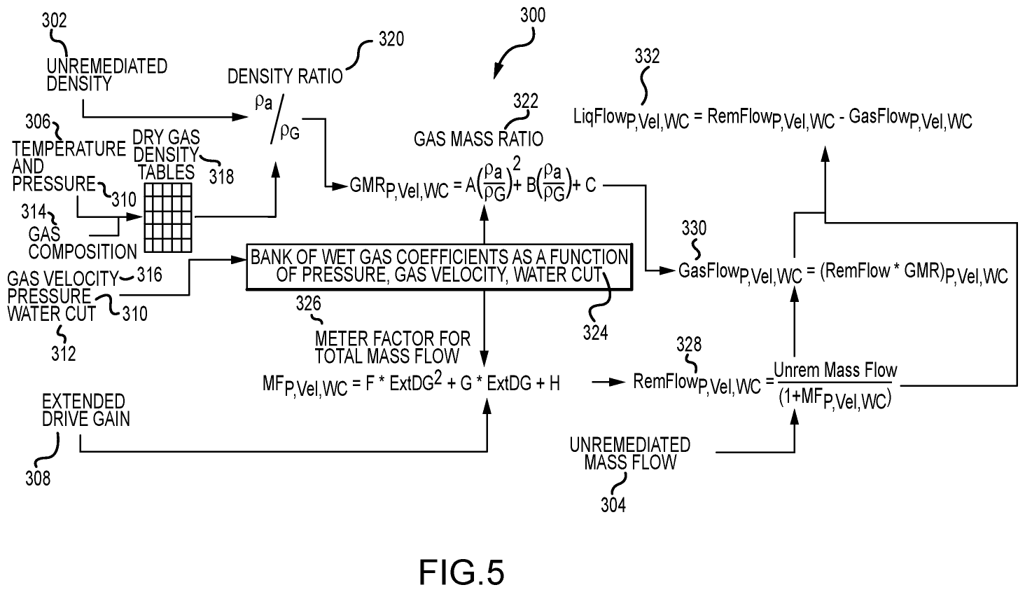

FIG. 5 illustrates an embodiment of a remediation process 300 for a wet gas flowing through the flowmeter 5. In a first step, fluid flow is measured through the flowmeter 5, and the unremediated density 302 and unremediated mass flow 304 are measured. The temperature 306 is measured by a measuring device such as a thermistor, thermocouple, or resistance temperature detector (RTD) that may be associated with the flowmeter 5 or may be external to the meter. Multiple temperature measuring devices may be present and an average or weighted average may be utilized to ascertain the temperature 306.

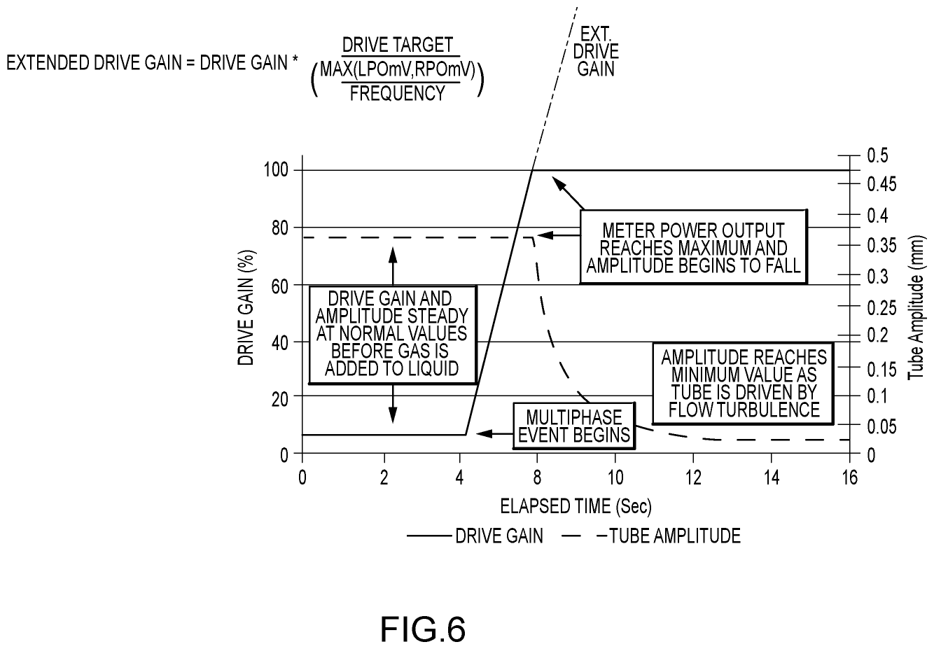

The extended drive gain 308 is also calculated by the flowmeter 5. The term drive gain by itself refers to the amount of electric current available to keep the flow tubes vibrating at the design amplitude. Drive Gain is measured in percentage, so if the sensor operates at normal conditions, it only needs a small amount of the total current available, for example 5% drive gain. However, if the sensor detects a decrease in tube amplitude, it can use more current to bring the amplitude back to the design value but now the drive gain would increase to 10% for example. During wet gas flow, the flow tubes are significantly damped and the meter will attempt to keep the tubes oscillating at design amplitude by using more energy, up until drive gain reaches 100%, where no more electric current can be delivered to the coil and magnet. The extended drive gain 308 is a calculated value that expresses the amount of energy that would be required to keep the tubes oscillating at design amplitude if the sensor didn't have a limit on how much current it can use. The concept of extended drive gain 308 is illustrated in FIG. 6.

Pressure 310 may be measured by a pressure meter or may be manually input into meter electronics 20, for example by an end-user. Multiple pressure measuring devices may be present and an average or weighted average may be utilized to ascertain the pressure 310.

Water cut 312 may be measured by a water cut analyzer or may be manually input into meter electronics 20, for example by an end-user. In an embodiment, the water cut analyzer is configured to measure water cut in the mist phase of wet gas flow.

Gas composition 314 may be measured by a gas analyzer or may be manually input into meter electronics 20, for example by an end-user. In an embodiment, a list of gas compositions can be provided for the user to select via an interface in communication with the meter electronics 20.

Gas velocity 316 is calculated by the flowmeter 5. In an embodiment, if the process flow sees intermittent periods of dry gas (identified by low dry gain, etc.), a ‘dry gas’ density at line conditions is stored in a memory variable and used for the calculation of density ratio. The volumetric flow rate is calculated by dividing mass flow rate 304 by the density 302. The gas velocity is calculated by dividing the volumetric flow rate by the area of the flowtubes 130, 130′.

A dry gas density table 318 is stored in meter electronics 20. The dry gas density table 318 uses, as inputs, one or more of the temperature 306, pressure 310, and gas composition 314, and based upon these inputs outputs a dry reference density, ρ_{g}.

The dry reference density, ρ_{g}, is divided into the unremediated density 302 to acquire a density ratio 320, as described above by Equation (4).

The density ratio 320 is utilized in determining the gas mass ratio 322. As noted above, the gas mass ratio is determined by using a bank of coefficients 324 determined from the particular pressure, velocity, and water cut, and is obtained via the density ratio calibration using a quadratic fit, as illustrated by the example of FIG. 3, and described by Equation (5).

The meter factor 326 utilizes the extended drive gain 308 and the bank of coefficients 324 determined from the particular pressure, velocity, and water cut, as illustrated by the example of FIG. 4, and described by Equation (6).

The meter factor 326 is then utilized, along with the unremediated mass flow rate 304, to determine the remediated mass flow rate 328, as described by Equation (7).

The gas mass ratio 322 and remediated flow rate 328 are then used to determine the dry gas mass flow rate 330, as described by Equation (8).

The liquid mass flow rate 332 is then calculated by subtracting the dry gas mass flow rate 330 from the remediated flow rate 328, as described by Equation (9).

In an embodiment, the flowmeter 5 provided can measure the performance of a well at the wellhead, thus drastically reducing cost, associated labor, and overall complexity. By monitoring each site individually, there are considerable benefits, with the most obvious being the elimination of a separator and the maintenance that goes with it. Another advantage is the fact that all the wells in a field can be monitored simultaneously, so that real-time determinations can be made regarding strategies and tactics for efficient production and Enhanced Oil Recovery (EOR). EOR involves the injection of water, C02, natural gas, surfactants, or steam; which can be expensive and must be applied at the right time with the right amount of media. Having real-time production data on an entire oilfield, for example without limitation, would give production and reservoir engineers valuable information on how to fine-tune their EOR. Operators would also have an advantage of early detection of wells that have developed problems and can act quickly to remediate the problems. Another advantage is that in a new field, the flow line gathering systems can incorporate a trunk-line-and-lateral design rather than having discrete flow lines to the test separator for each well. This saves capital costs on pipe, welding, trenching, and the real estate required.

The embodiments provided herein improve upon current wet gas metering by adding density and water cut inputs to better resolve multi-phase measurement.

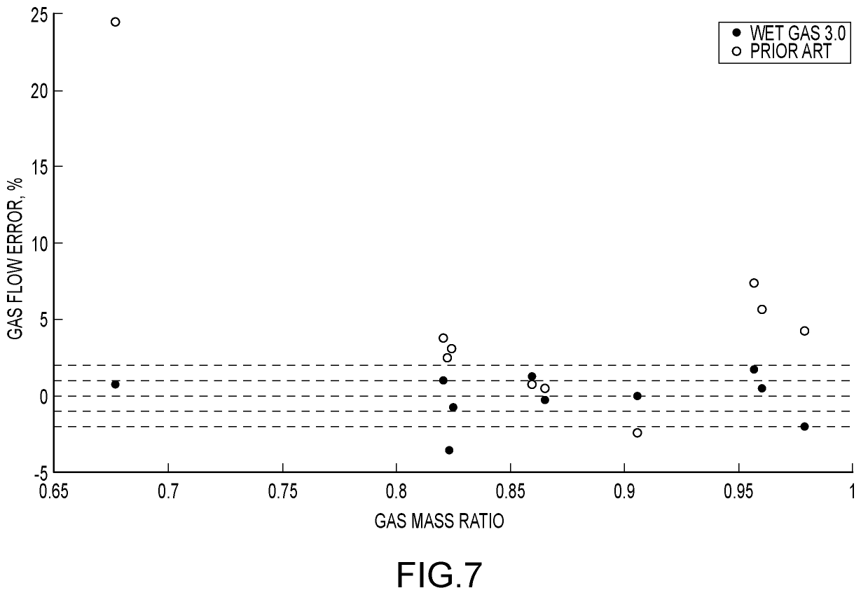

Additionally, the plurality of calibration curves available based upon the bank of coefficients 324 reduces the residual error from curve fitting, resulting in better prediction on liquid loading. This is in part due to utilizing pressure, gas superficial velocity, and water cut. The prior art wet gas metering results in higher errors (current specs are 7% for gas when liquid loading is less than 20% by mass). The liquid accuracy improvement is immense: being 10% accuracy for most of the operating envelope, whereas current metering can be off by over 100% in some operating conditions. FIG. 7 illustrates a prior art flowmeter vs. a flowmeter employing an embodiment provided herein. The diamonds represent the post-processed data using this new method and show accuracy within 2% for most points. In contrast, the prior art flowmeter shows accuracy within 7% for most points and it greatly deteriorates at higher liquid loading showing close to 25% error at gas mass ratio below 0.7. This is an example at one particular set of process conditions.

The present description depicts specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein may be applied to other embodiments than those described above and shown in the accompanying figures. Accordingly, the scope of the invention is determined from the following claims.

We claim:

1. A method for improving flowmeter accuracy, wherein the flowmeter comprises at least one flow tube, at least one pickoff sensor attached to the flow tube, at least one driver attached to the flow tube, and meter electronics in communication with the at least one pickoff sensor and driver, comprising the steps of:
vibrating at least one flow tube in a drive mode vibration with the at least one driver;
receiving a sensor signal based on a vibrational response to the drive mode vibration from the at least one pickoff sensor;
deriving an unremediated density with the flowmeter;
deriving an unremediated mass flow with the flowmeter;
deriving an extended drive gain with the flowmeter;
receiving at least one flow variable;
calculating a density ratio;
providing a plurality of wet gas coefficients;
calculating a dry gas mass flow rate with the density ratio and at least one of the plurality of wet gas coefficients.

2. The method of claim 1, wherein the flow variable comprises pressure, and wherein the pressure is one of a measured input and a user input.

3. The method of claim 1, wherein the flow variable comprises water cut.

4. The method of claim 3, wherein the water cut is measured with a water cut analyzer in communication with the meter electronics.

5. The method of claim 1, wherein the flow variable comprises temperature.

6. The method of claim 1, comprising the step of deriving an extended drive gain with the flowmeter.

7. The method of claim 1, wherein calculating a density ratio comprises dividing the unremediated density by a dry reference density.

8. The method of claim 7, comprising retrieving the dry reference density from meter electronics.

9. The method of claim 8, wherein the dry reference density retrieved from meter electronics is determined by at least one of temperatures, pressure, and gas composition.

10. The method of claim 1, comprising the step of deriving a liquid mass flow rate by subtracting the dry gas mass flow rate from a remediated mass flow rate.

11. The method of claim 10, wherein the remediated mass flow rate is derived from the unremediated mass flow rate and a meter factor.

12. The method of claim 11, wherein meter factor is derived from an extended drive gain and the plurality of wet gas coefficients.

13. The method of claim 1, wherein the wet gas coefficients are a function of a plurality of the flow variables.

14. The method of claim 1, wherein the wet gas coefficients are a function of pressure, gas velocity, drive gain, and water cut.

15. The method of claim 1, wherein the step of calculating a dry gas mass flow rate with the density ratio and at least one of the plurality of wet gas coefficients comprises using a gas mass ratio derived from the density ratio and the plurality of wet gas coefficients.

16. The method of claim 15, wherein the gas mass ratio is obtained using density ratio calibration and wet gas coefficients using a quadratic fit.

17. The method of claim 12, wherein the meter factor is obtained via an extended drive gain and the plurality of wet gas coefficients using a quadratic fit.

18. Meter electronics (20) for a flowmeter (5) configured to improve measurement accuracy, wherein the flowmeter (5) comprises:
at least one flow tube (130, 130′);
at least one pickoff sensor (170L, 170R) attached to the at least on flow tube (130, 130′); and
at least one driver (180L, 180R) attached to the flow tube (130, 130′);
wherein the meter electronics (20) are in communication with the at least one pickoff sensor (170L, 170R) and the at least one driver (180L, 180R), and configured to:
vibrate at least one flow tube (130, 130′) in a drive mode vibration with the at least one driver (180L, 180R);
receive a sensor signal based on a vibrational response to the drive mode vibration from the at least one pickoff sensor (170L, 170R);
wherein the meter electronics (20) is further configured to:
derive an unremediated density with the flowmeter;
derive an unremediated mass flow with the flowmeter;
derive an extended drive gain with the flowmeter;
receive at least one flow variable;
calculate a density ratio;
provide a plurality of wet gas coefficients; and
calculate a dry gas mass flow rate with the density ratio and at least one of the plurality of wet gas coefficients.

19. The meter electronics (20) of claim 18, wherein the flow variable comprises pressure, and wherein the pressure is one of a measured input and a user input.

20. The meter electronics (20) of claim 18, wherein the flow variable comprises water cut.

21. The meter electronics (20) of claim 20, wherein the water cut is measured with a water cut analyzer in communication with the meter electronics.

22. The meter electronics (20) of claim 18, wherein the flow variable comprises temperature.

23. The meter electronics (20) of claim 18, wherein the meter electronics is further configured to derive an extended drive gain.

24. The meter electronics (20) of claim 18, wherein calculating a density ratio comprises dividing the unremediated density by a dry reference density.

25. The meter electronics (20) of claim 24, comprising retrieving the dry reference density from meter electronics.

26. The meter electronics (20) of claim 25, wherein the dry reference density retrieved from meter electronics is determined by at least one of temperature, pressure, and gas composition.

27. The meter electronics (20) of claim 18, wherein the meter electronics is further configured to derive a liquid mass flow rate by subtracting the dry gas mass flow rate from a remediated mass flow rate.

28. The meter electronics (20) of claim 27, wherein the remediated mass flow rate is derived from the unremediated mass flow rate and a meter factor.

29. The meter electronics (20) of claim 28, wherein meter factor is derived from an extended drive gain and the plurality of wet gas coefficients.

30. The meter electronics (20) of claim 18, wherein the wet gas coefficients are a function of a plurality of the flow variables.

31. The meter electronics (20) of claim 18, wherein the wet gas coefficients are a function of pressure, gas velocity, and water cut.

32. The meter electronics (20) of claim 18, wherein calculating a dry gas mass flow rate with the density ratio and at least one of the plurality of wet gas coefficients comprises using a gas mass ratio derived from the density ratio and the plurality of wet gas coefficients.

33. The meter electronics (20) of claim 32, wherein the gas mass ratio is obtained using density ratio calibration and wet gas coefficients using a quadratic fit.

34. Meter electronics (20) of claim 29, wherein the meter factor is obtained from via an extended drive gain and the plurality of wet gas coefficients using a quadratic fit.
